(19) United States
(12) Patent Application Publication
(10) Pub. No.: US 2025/0136016 A1
(43) Pub. Date: May 1, 2025

(54) ACCESSORY SYSTEM FOR CONNECTING AN ACCESSORY TO A VEHICLE

(71) Applicant: BOMBARDIER RECREATIONAL PRODUCTS INC., Valcourt (CA)

(72) Inventors: Pierre-Luc ROBILLARD, Sherbrooke (QC); Karl DERY ST-CYR, St-Denis-de-Brompton (CA); Bart VANDENBOGAARD, Racine (CA); Mathieu MERCIER, Sherbrooke (CA); Alexandre MORIN-SAVARD, Sherbrooke (CA); Michel BOURASSA, Sherbrooke (CA); Samuel SIMONEAU, St-Denis-de-Brompton (CA)

(21) Appl. No.: 18/682,984

(22) PCT Filed: Aug. 9, 2022
(86) PCT No.: PCT/IB2022/057430

§ 371 Date: Feb. 12, 2024

Related U.S. Application Data
(60) Provisional application No. 63/231,622, filed on Aug. 10, 2021.

(51) Int. Cl. B60R 11/00

(52) U.S. Cl. CPC B60R 11/00; B60R 2011/0059

(57) ABSTRACT

A connecting base for connecting an accessory to a vehicle includes: an attachment portion configured to be connected to the vehicle; and at least one post-receiving portion connected to the attachment portion. Each of the at least one post-receiving portion defines an opening configured to receive a post connected to the accessory. The opening is defined in an upper surface of the connecting base. Each of the at least one post-receiving portion includes: an inner peripheral surface defining the opening, the inner peripheral surface being shaped to be at least partially mated with an outer peripheral surface of the post; and a rib protruding from the inner peripheral surface, the rib being configured to engage a groove defined by the outer peripheral surface of the post. An accessory connector and an accessory system including the connecting base and the accessory connector are also contemplated.

### CROSS-REFERENCE

The present application claims priority from U.S. Provisional Patent Application No. 63/231,622, filed Aug. 10, 2021, the entirety of which is incorporated by reference herein.

### FIELD OF TECHNOLOGY

The present technology relates to accessory systems for connecting an accessory to a vehicle.

### BACKGROUND

Some vehicles are equipped with an accessory system that allows quick connection of accessories thereto. For example, some off-road vehicles have such an accessory system to connect a storage container (e.g., a bag or storage box) or other accessory to the vehicle. However, such accessory systems may not retain accessories securely enough, and can also be difficult to operate. Notably, as vehicles are often subjected to momentums during operation thereof, the accessories can be subjected to movement which could dislodge the accessories from the vehicle if not properly secured in place.

In view of the foregoing, there is a need for an accessory system for a vehicle that addresses at least some of these drawbacks.

### SUMMARY

It is an object of the present technology to ameliorate at least some of the inconveniences present in the prior art.

According to an aspect of the present technology, there is provided a connecting base for connecting an accessory to a vehicle. The connecting base comprises: an attachment portion configured to be connected to the vehicle; and at least one post-receiving portion connected to the attachment portion, each of the at least one post-receiving portion defining an opening configured to receive a post connected to the accessory, the opening being defined in an upper surface of the connecting base, each of the at least one post-receiving portion comprising: an inner peripheral surface defining the opening, the inner peripheral surface being shaped to be at least partially mated with an outer peripheral surface of the post; and a rib protruding from the inner peripheral surface, the rib being configured to engage a groove defined by the outer peripheral surface of the post.

In some embodiments, the rib extends along a majority of a depth of the opening measured downward from the upper surface.

In some embodiments, the rib extends generally vertically.

In some embodiments, the rib is a first rib; the groove is a first groove, the outer peripheral surface of the post comprising a second groove; each of the at least one post-receiving portion further comprises a second rib protruding from the inner peripheral surface for engaging the second groove defined by the outer peripheral surface of the post; and the first and second ribs are disposed on opposite sides of the opening.

In some embodiments, the opening extends from upper surface of the connecting base to a lower surface of the connecting base.

In some embodiments, the opening has a generally hexagonal shape.

In some embodiments, the at least one post-receiving portion is a plurality of post-receiving portions.

In some embodiments, a plane extends through the rib of each post-receiving portion of the plurality of post-receiving portions.

In some embodiments, the connecting base is generally elongated in a given direction, the openings being spaced from one another in the given direction.

In some embodiments, the attachment portion is configured for removably connecting the connecting base to the vehicle.

In some embodiments, the vehicle comprises a rail; and the attachment portion is configured to be clipped toollessly onto the rail, the attachment portion being sufficiently flexible to be elastically deformed when being clipped onto the rail.

In some embodiments, the attachment portion is configured to partially surround part of the rail to retain the connecting base onto the rail.

In some embodiments, the attachment portion is configured to partially surround an upper portion of the rail.

In some embodiments, the attachment portion defines at least one fastening opening configured to receive a fastener to fasten the connecting base to the vehicle.

In some embodiments, an axis of the at least one fastening opening extends in a direction generally perpendicular to a direction of insertion of the post into the opening of the at least one post-receiving portion.

In some embodiments, an accessory system for a vehicle comprises: the connecting base; and an accessory connector configured to be connected to an accessory, the accessory connector comprising a post configured to be received in the opening of the at least one post-receiving portion of the connecting base, the post comprising an outer peripheral surface having a shape corresponding to the inner peripheral surface of the at least one post-receiving portion, the outer peripheral surface defining a groove configured to slidingly receive the rib of the post-receiving portion therein.

In some embodiments, the accessory connector further comprises: a supporting portion configured to be connected to the accessory; and an overhanging portion extending from the supporting portion, the post extending downward from the overhanging portion.

In some embodiments, the supporting portion is configured to be connected to the accessory on a side of the supporting portion opposite the overhanging portion.

In some embodiments, the accessory connector further comprises a movement limiter connected to the supporting portion; the movement limiter is movable between a first position and a second position; in the first position, the movement limiter is positioned to interact with the connecting base to limit sliding movement of the post within the opening; and in the second position, the movement limiter is positioned to allow sliding movement of the post within the opening.

In some embodiments, the movement limiter is biased to be in the first position.

In some embodiments, the movement limiter is movable towards and away from the supporting portion; and a tip of the movement limiter is further from the supporting portion in the first position than in the second position.

In some embodiments, the at least one post-receiving portion of the connecting base includes a first post-receiving portion and a second post-receiving portion; the accessory connector is a first accessory connector, the post being a first post configured to be received in the opening of the first post-receiving portion; and the accessory system further comprises a second accessory connector configured to be connected to the accessory, the second accessory connector comprising a second post configured to be received in the opening of the second post-receiving portion.

In some embodiments, the accessory system further comprises a link interconnecting the first and second accessory connectors for simultaneously removing the first and second posts from within the openings of the first and second post-receiving portions.

According to another aspect of the present technology, there is provided an accessory connector. The accessory connector comprises: a supporting portion configured to be connected to the accessory; and a post connected to the supporting portion, the post being configured to be received in an opening of a connecting base, the post comprising an outer peripheral surface defining a groove configured to slidingly receive a rib protruding from an inner peripheral surface of the connecting base defining the opening.

In some embodiments, the accessory connector further comprises an overhanging portion extending from the supporting portion, the post extending downward from the overhanging portion.

In some embodiments, the supporting portion is configured to be connected to the accessory on a side of the supporting portion opposite the overhanging portion.

In some embodiments, the accessory connector further comprises a movement limiter connected to the supporting portion; the movement limiter is movable from a first position to a second position; in the first position, the movement limiter is positioned to interact with the connecting base to limit sliding movement of the post within the opening; and in the second position, the movement limiter is positioned to allow sliding movement of the post within the opening.

In some embodiments, the movement limiter is biased to be in the first position.

In some embodiments, the movement limiter is movable towards and away from the supporting portion; and a tip of the movement limiter is further from the supporting portion in the first position than in the second position.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of an accessory and part of a vehicle implementing an accessory system according to an embodiment of the present technology, including a connecting base connected to the vehicle and accessory connectors connected to the accessory, the accessory connectors being shown disconnected from the connecting base;

FIG. 2 is a top plan view of the accessory and the accessory system of FIG. 1, showing the accessory connectors connected to the connecting base;

FIG. 3 is a perspective view, taken from a top, front, left side, of the connecting base of the accessory system of FIG. 1;

FIG. 4 is a perspective view, taken from a bottom, rear, right side, of the connecting base of FIG. 3;

FIG. 5 is a front elevation view of the connecting base of FIG. 3;

FIG. 6 is a rear elevation view of the connecting base of FIG. 3;

FIG. 7 is a top plan view of the connecting base of FIG. 3;

FIG. 8 is a bottom plan view of the connecting base of FIG. 3;

FIG. 9 is a cross-sectional view of the connecting base of FIG. 3 taken along line 9-9 in FIG. 7;

FIG. 10 is a perspective view, taken from a top, rear, left side, of a cross-section of the connecting base of FIG. 3 taken along line 10-10 in FIG. 3;

FIG. 11 is a perspective view, taken from a top, rear, left side, of one of the accessory connectors of the accessory system of FIG. 1;

FIG. 12 is a perspective view, taken from a bottom, front, right side, of the accessory connector of FIG. 11;

FIG. 13 is a rear elevation view of the accessory connector of FIG. 11;

FIG. 14 is a right side elevation view of the accessory connector of FIG. 11;

FIG. 15 is a bottom plan view of the accessory connector of FIG. 11;

FIG. 16 is a perspective view, taken from a bottom, rear, right side, of a cross-section of the accessory connector of FIG. 11 taken along line 16-16 in FIG. 14;

FIG. 17 is a right side elevation view of one of the accessory connectors and the connecting base of the accessory system of FIG. 1, showing the accessory connected to the connecting base;

FIG. 18 is a perspective view, taken from a top, rear, right side, of a cross-section of the accessory connector and the connecting base of FIG. 17 taken along line 18-18 in FIG. 17;

FIG. 19 is a right side elevation view of the accessory connector and the connecting base of FIG. 17, showing a movement limiter of the accessory connector in a free position;

FIG. 20 is a perspective view, taken from a top, right side, of a connecting base according to another embodiment;

FIG. 21 is a left side elevation view of connecting base of FIG. 20;

FIG. 22 is a top plan view of the connecting base of FIG. 20;

FIG. 23 is a cross-sectional view of the connecting base of FIG. 20 taken along line 23-23 of FIG. 22;

FIG. 24 is a perspective view, taken from a top, front, left side, of a watercraft configured to be equipped with an accessory via the accessory system;

FIG. 25 is a perspective view of part of a rail of the watercraft of FIG. 24; and

FIG. 26 is a perspective view of the rail of FIG. 25 with the connecting base of FIG. 20 connected thereto.

### DETAILED DESCRIPTION

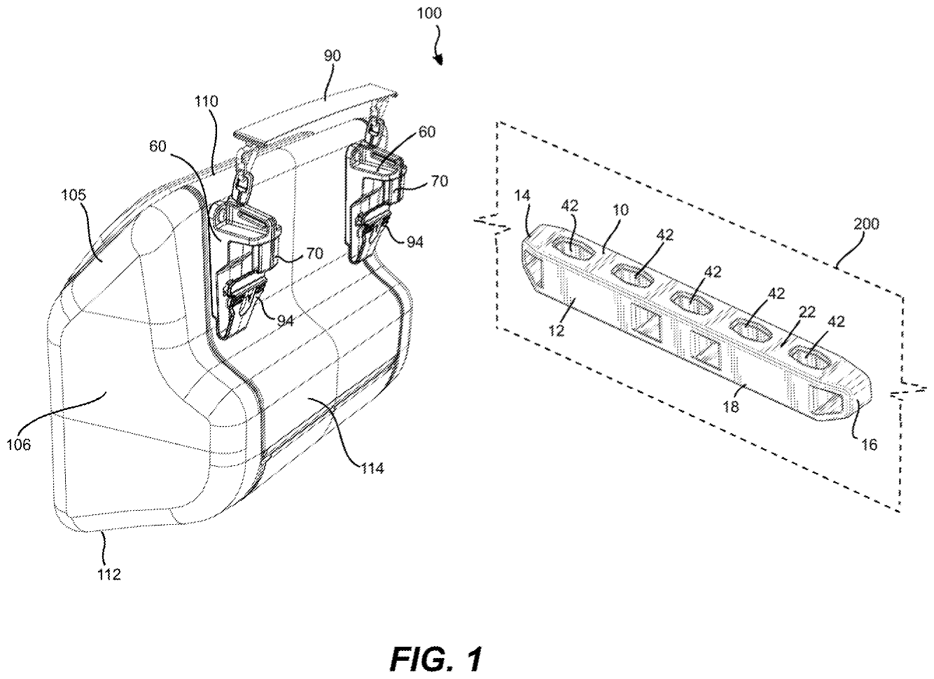

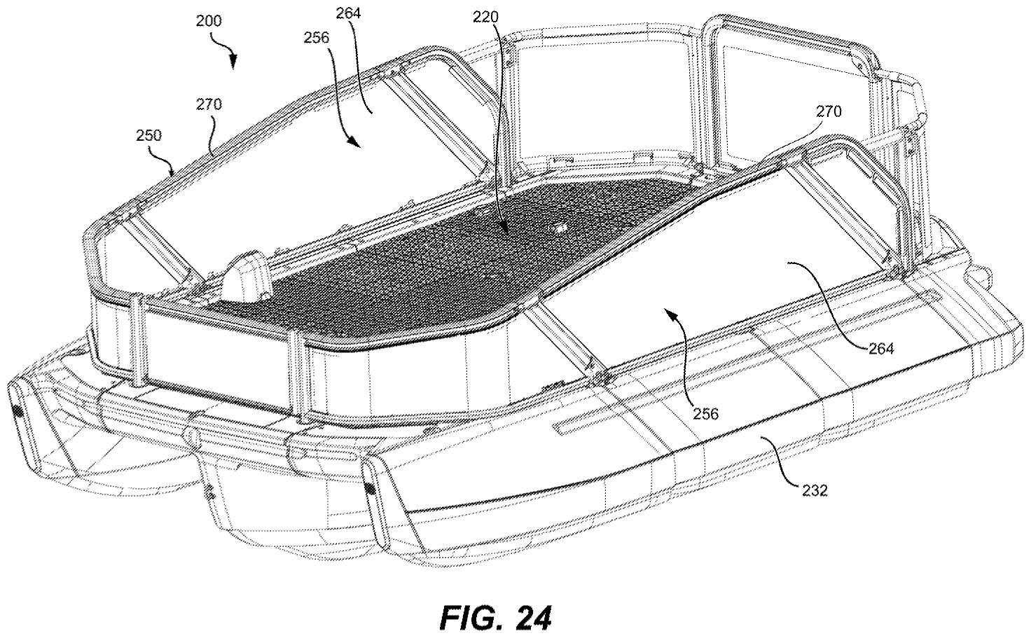

With reference to FIG. 1, an accessory system 100 is provided for connecting an accessory 105 to a vehicle 200. The vehicle 200 may be any suitable vehicle that can benefit from the accessory system 100 to connect accessories thereto. For instance, as shown in FIG. 24, the vehicle 200 may be a watercraft, namely a pontoon boat. The vehicle 200 may be any other type of vehicle in other embodiments. For instance, in some embodiments, the vehicle 200 may be an off-road vehicle having wheels (e.g., an all-terrain vehicle (ATV), a side-by-side vehicle (SSV)) or other types of ground-engaging members such as a ski and/or an endless track (e.g., a snowmobile).

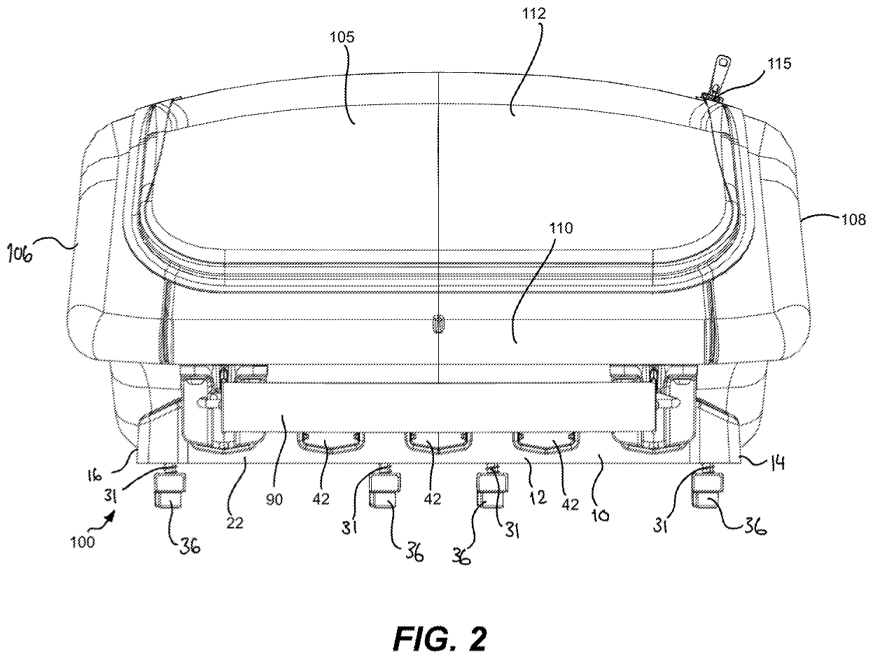

The accessory 105 may also be any suitable type of accessory. For instance, in this embodiment, as shown in FIGS. 1 and 2, the accessory 105 is a storage container defining an internal volume for storing items therein, and has opposite lateral ends 106, 108, an upper end 110, a lower end 112, and a front face 112 and a rear face 114. As shown in FIG. 2, the storage container 105 has a closure device 115, namely a zip fastener, disposed on the front face 112 for selectively opening and closing a container opening through which the internal volume of the storage container 105 can be accessed. The storage container 105 may be configured differently in other embodiments. Moreover, it is to be understood that the accessory system 100 described herein could be used for other types of accessories such as a jerry can, a fishing rod tube, a rack for skis and/or a snowboard and/or a wakeboard.

As shown in FIGS. 1 and 2, in this embodiment, the accessory system 100 includes a connecting base 10 that is connected to the vehicle 200 and two accessory connectors 60 that are connected to the accessory 105. As will be described below, the connecting base 10 and the accessory connectors 60 interact with one another to secure the accessory 105 to the vehicle 200.

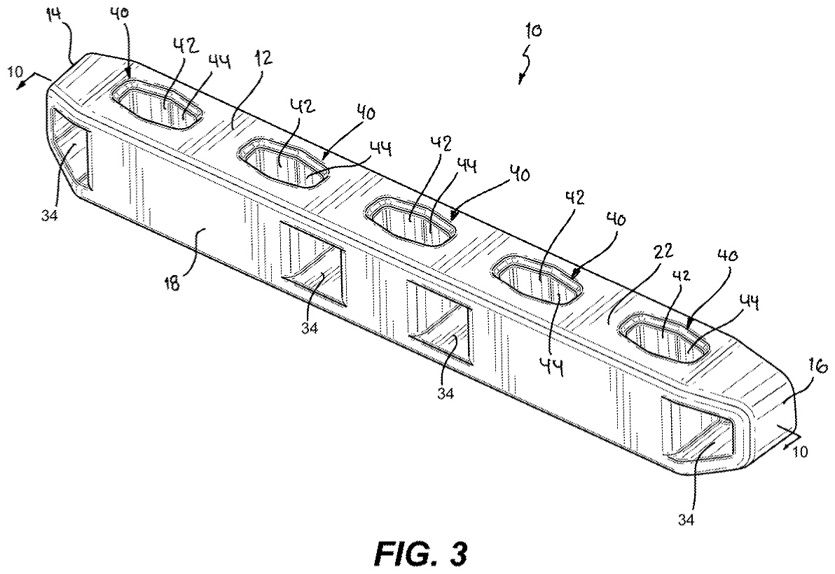

With reference to FIGS. 3 to 8, the connecting base 10 has a base body 12 which, in this embodiment, is generally elongated in a direction from a first end 14 to a second end 16 opposite the first end 14. Given its elongated shape, the connecting base 10 may also be referred to as a “mounting rail”. The base body 12 also has a front surface 18 and a rear surface 20 on front and rear sides of the base body 12 respectively, as well as an upper surface 22 and a lower surface 24 on upper and lower sides of the base body 12 respectively.

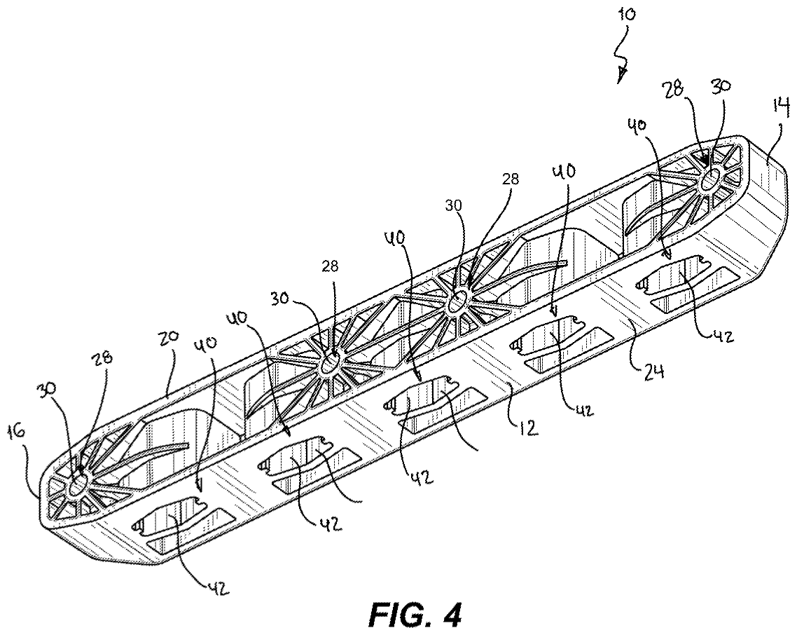

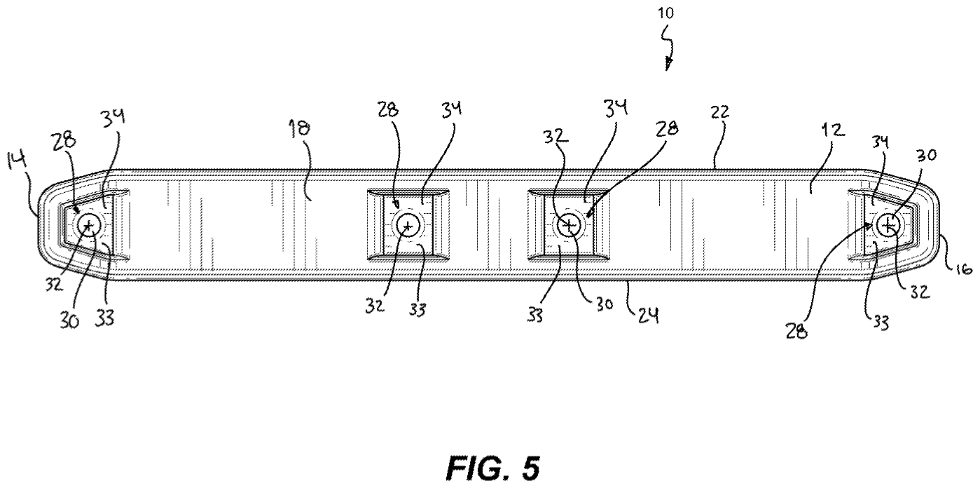

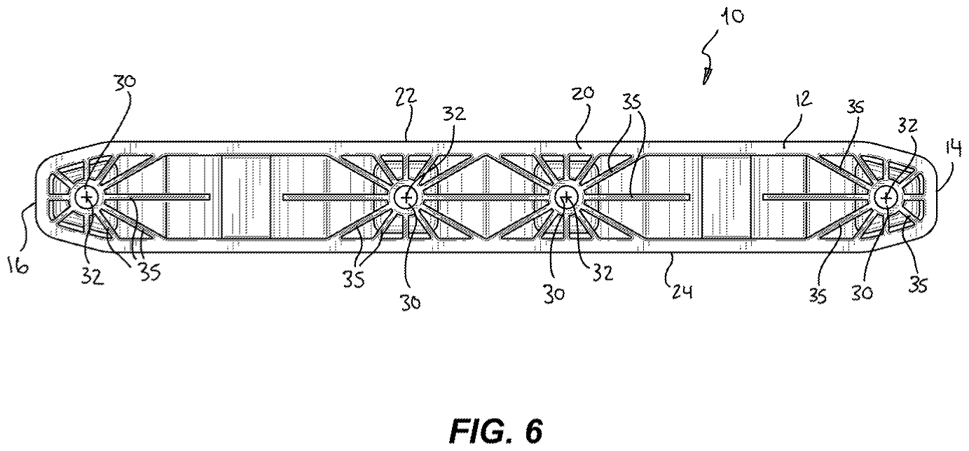

As shown in FIGS. 4 to 6, in this embodiment, the connecting base 10 has a plurality of attachment portions 28 that, in use, are the parts of the base body 12 that are connected to the vehicle 200. In this embodiment, four attachment portions 28 are provided and are spaced from one another in a lateral direction. Each attachment portion 28 defines a fastening opening 30 for receiving a corresponding fastener 31 (partly shown in FIG. 2) therein. The fastening opening 30 defines an axis 32 (FIGS. 5, 6) central to the fastening opening 30 and extending generally in a front-to-rear direction of the connecting base 10. In particular, in this embodiment, as shown in FIG. 5, each fastening opening 30 is defined, on the front side of the base body 12, by a front-facing shoulder surface 33 and, on the rear side of the base body 12, by the rear surface 20. Notably, in this embodiment, the base body 12 defines a plurality of pockets 34 in the front surface 18, and the shoulder surfaces 33 define respective ones of the fastening openings 30. On the rear side of the base body 12, as shown in FIGS. 4 and 6, a plurality of ribs 35 define in part the rear surface 20 of the base body 12 and extend generally radially from respective ones of the fastening openings 30 for reinforcing the attachment portions 28.

In use, in order to connect the connecting base 10 to the vehicle 10, the rear side of the connecting base 10 is positioned to face a part of the vehicle 200, and the attachment portions 28 are positioned such that the fastening openings 30 are aligned with corresponding openings defined by respective anchoring parts 36 that are part of or connected to the vehicle 200. The fasteners 31 are then inserted into the fastening openings 30 and are threadedly received by the anchoring parts 36 to secure the connecting base 10 to the vehicle 200. In this example, part of an accessory connecting wall (not shown) of the vehicle 200 is disposed between the anchoring parts 36 and the connecting base 10 such that, when the connecting base 10 is fastened to the anchoring parts 36, the accessory connecting wall is compressed therebetween.

Returning now to FIG. 3, the connecting base 10 also has a plurality of post-receiving portions 40 connected to the attachment portions 28 via the base body 12. In this embodiment, five post-receiving portions 40 are provided and are spaced apart from one another in the lateral direction (i.e., in the direction in which the connecting base 10 is elongated). Each post-receiving portion 40 defines a post opening 42 configured to receive a post 70 of a corresponding one of the accessory connectors 60 (FIGS. 1, 2) as will be described in more detail below. The post opening 42 of each post-receiving portion 40 is defined in the upper surface 22 of the base body 12 and, in this embodiment, extends to the lower surface 24. The depth of the post opening 42 (measured downward from the upper surface 22) is equal to the distance between the upper and lower surfaces 22, 24. As such, the post opening 42 extends through the base body 12. In other embodiments, the post openings 42 may not extend to the lower surface 24. As will be described in more detail below, the posts 70 are inserted into the post openings 42 in a generally vertical direction from the upper side of the connecting base 10. The direction of insertion of the posts 70 into the post openings 42 can therefore be said to be generally perpendicular to the axes 32 of the fastening openings 30 of the attachment portions 28.

In this embodiment, the post openings 42 have a generally hexagonal shape, and in particular an elongated hexagonal shape. It is to be understood that the shape of the post openings 42 refers to the shape thereof as described in the upper surface 22 or the lower surface 24 (i.e., in a plane normal to an axis of the corresponding post opening 42). It is contemplated that the post openings 42 could have another shape.

Each post-receiving portion 40 also includes an inner peripheral surface 44 that defines the corresponding post opening 42 of the post-receiving portion 40. The inner peripheral surface 44 of each post-receiving portion 40 is shaped to be at least partially mated with an outer peripheral surface 72 of the corresponding post 70. Notably. in this embodiment, the inner peripheral surface 44 has a generally hexagonal cross-sectional profile to match a corresponding shape of the corresponding post 70. In particular, the generally hexagonal cross-sectional profile of the inner peripheral surface 44 is observed along a plane normal to the direction of insertion of the post 70 into the post opening 42. Moreover, the inner peripheral surface 44 has an upper chamfered portion 45 adjacent the upper surface 22 to facilitate insertion of the corresponding post 70 into the post opening 42.

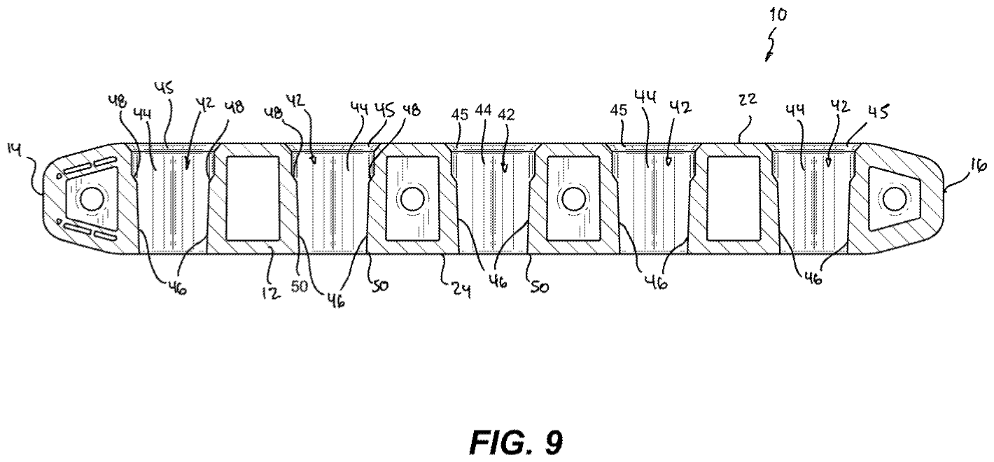

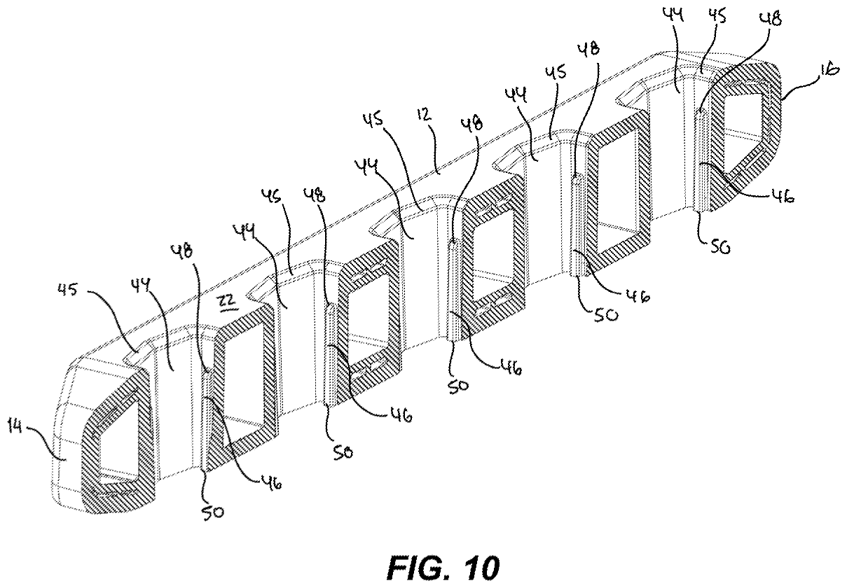

Each post-receiving portion 40 also includes a pair of ribs 46 protruding from the inner peripheral surface 44. The ribs 46 are configured to engage respective grooves 74 defined by the outer peripheral surface 72 of the corresponding post 70. As best shown in FIGS. 9 and 10, the ribs 46 extend generally vertically along the inner peripheral surface 44 from an upper rib end 48 to a lower rib end 50. In this embodiment, the upper rib end 48 is disposed vertically lower than the upper surface 22, and in particular lower than the upper chamfered portion 45 of the inner peripheral surface 44, while the lower rib end 50 is vertically aligned with the lower surface 24 of the base body 12 (i.e., the ribs 46 extend to the lower surface 24). The ribs 46 extend along a majority of a depth of the corresponding opening 42 measured downward from the upper surface 22. In particular, in this embodiment, the depth of the opening 42 is measured from the upper surface 22 to the lower surface 24.

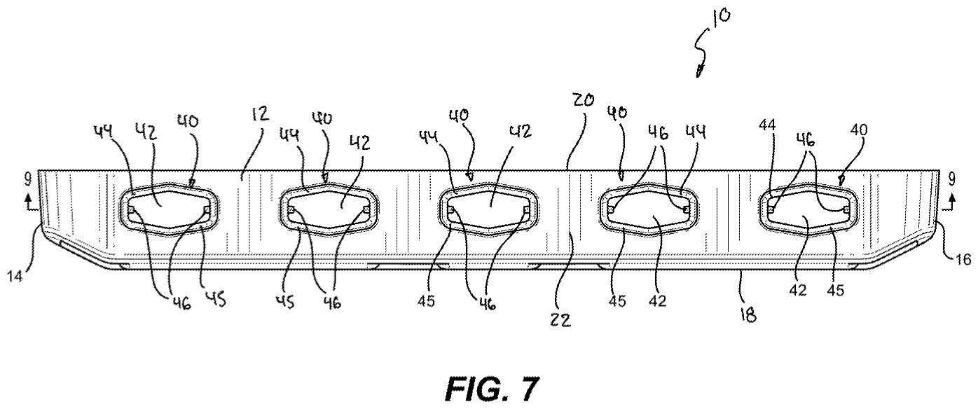

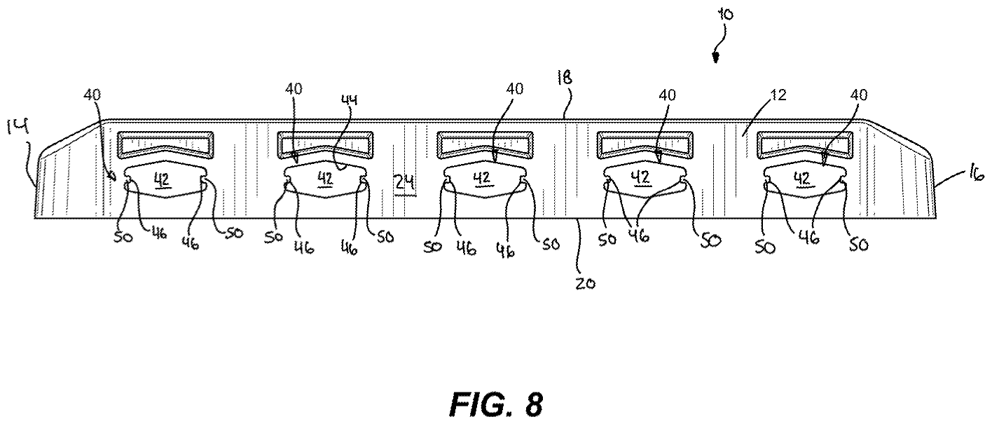

As shown in FIGS. 7 and 8, in this embodiment, the ribs 46 of each post-receiving portion 40 are disposed on opposite sides of the corresponding post opening 42. In particular, one rib 46 is disposed at a left end of the post opening 42 while the other rib 46 is disposed at a right end of the post opening 42. As such, a plane can be traced extending through the ribs 46 of each of the post-receiving portions 40 since all of the ribs 46 are aligned with one another in the front-to-rear direction of the connecting base 10. It is contemplated that, in other embodiments, a single rib 46 could be provided instead of two ribs 46. For example, only the left or right rib 46 could be provided.

The ribs 46 may be helpful to provide additional surface area to mate with surfaces of the corresponding post 70, thereby allowing the post-receiving portions 40 to more securely retain the corresponding posts 70. Moreover, the ribs 46 may be helpful to provide better rotational retention of the corresponding post 70. For instance, in embodiments in which the shape of the inner peripheral surfaces 44 do not include corners (e.g., a circular shape), the ribs 46 may reduce rotational movement of the posts 70 within the post openings 42.

In this embodiment, the connecting base 10 is made integrally as a single-piece component such that all the portions of the connecting base 10 are formed by a continuous material. Notably, in this embodiment, the connecting base 10 is a molded component made of plastic.

As will be described in more detail below, the connecting base 10 may be configured differently in other embodiments.

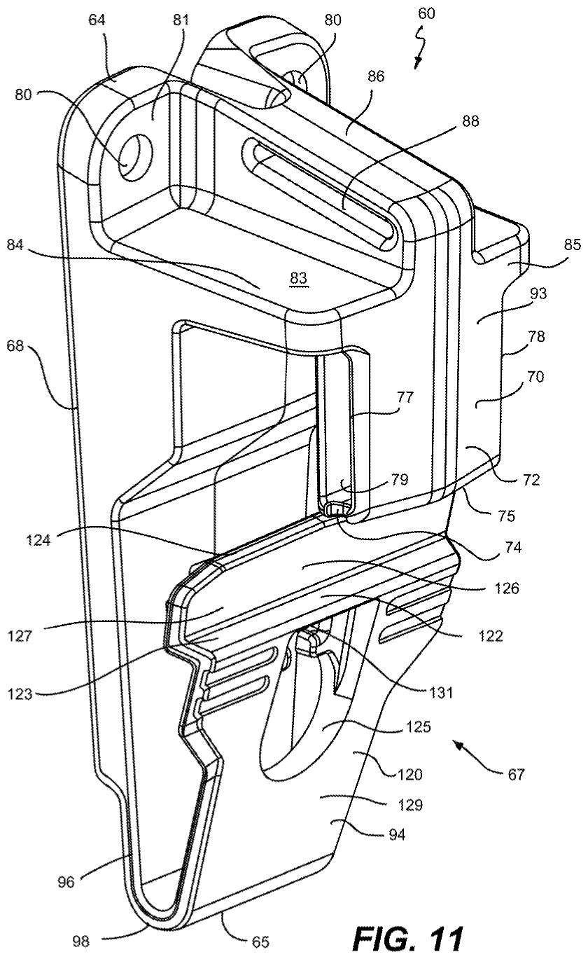

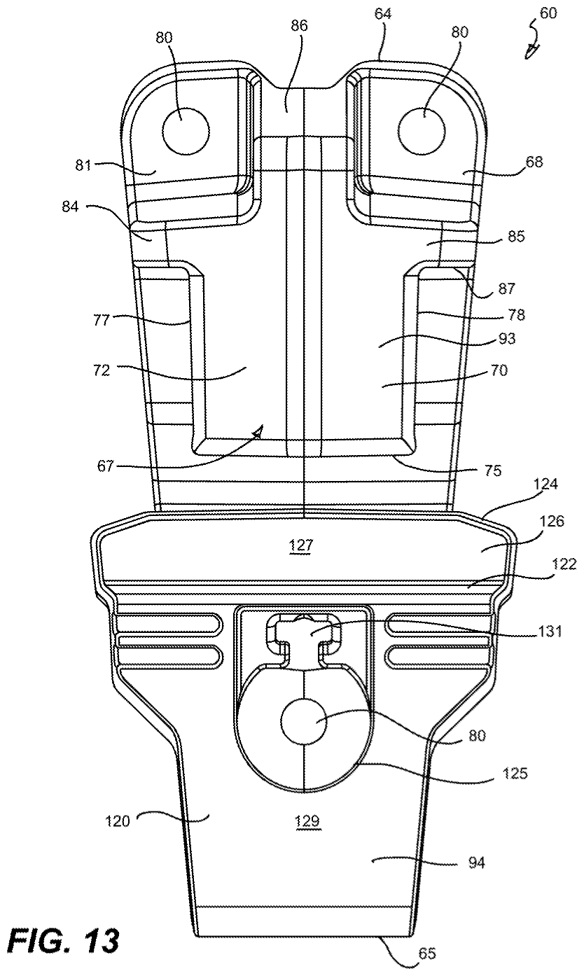

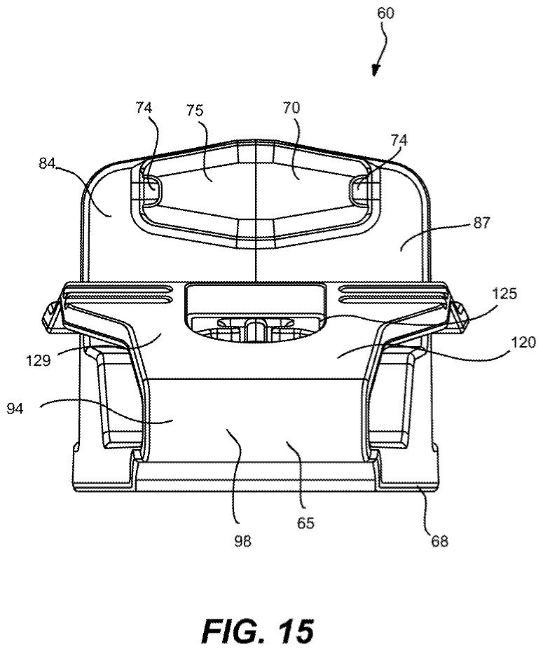

The accessory connectors 60 will now be described in greater detail with reference to FIGS. 11 to 16. As the two accessory connectors 60 of the accessory system 100 are identical, only one of the accessory connectors 60 will be described herein. It is to be understood that the same description applies to both accessory connectors 60.

The accessory connector 60 has an upper end 64, a lower end 65 opposite the upper end 64, a front side 66 and a rear side 67. The accessory connector 60 has a supporting portion 68 that, in use, is connected to the accessory 105. In this embodiment, the supporting portion 68 defines the upper end 64 of the accessory connector 60 and extends generally vertically downward from the upper end 64. The supporting portion 68 defines three fastening openings 80 through which, in use, fasteners are inserted to connect the accessory connector 60 to the accessory 105. For instance, the fasteners may be received within threaded openings defined by corresponding fasteners of the accessory 105. An overhanging portion 84 of the accessory connector 60 extends rearward from the supporting portion 68 on the rear side 67 of the accessory connector 60. Notably, in this embodiment, the overhanging portion 84 extends generally perpendicular to the supporting portion 68. The supporting portion 68 is thus connected to the accessory 105 on a side of the supporting portion 68 opposite the overhanging portion 84. The overhanging portion 84 is disposed near to, but vertically lower than, the upper end 64 of the accessory connector 60.

In this embodiment, an upper linking portion 86 extends upward from an upper surface 83 of the overhanging portion 84. In particular, the upper linking portion 86 extends in the front-to-rear direction from a rear surface 81 of the supporting portion 68 to a rear end 85 of the overhanging portion 84. The upper linking portion 86 defines an aperture 88. In this embodiment, the aperture 88 is in the form of a slit. In use, a strap may be inserted through the aperture for handling the accessory connector 60 or for attaching other components, such as other accessories, to the accessory connector 60.

As mentioned above, the accessory connector 60 includes the post 70 which is configured to be inserted into any one of the post openings 42 of the connecting base 10. As can be seen in FIGS. 11 to 14, the post 70 extends vertically downward from the overhanging portion 84, notably from the rear end 85 of the overhanging portion 84. The post 70 thus extends generally parallel to the supporting portion 68 and is spaced therefrom in the front-to-rear direction of the accessory connector 60. A lower end 75 of the post 70 is disposed vertically lower than a lower surface 87 of the overhanging portion 84.

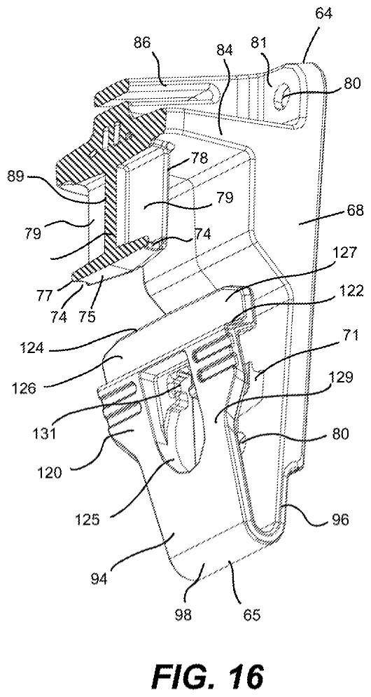

The outer peripheral surface 72 of the post 70 has a shape corresponding to the inner peripheral surface 44 of any of the post-receiving portions 40 of the connecting base 10. Notably, the outer peripheral surface 72 has a generally hexagonal shape and is dimensioned to slidingly fit within the corresponding post opening 42. More specifically, the outer peripheral surface 72 of the post 70 defines two opposite lateral ends 77, 78 of the post 70 as well as front and rear faces 92, 93 extending between the opposite lateral ends 77, 78. As best shown in FIG. 16, at each lateral end 77, 78, the post defines a recess 79 that extends from a respective one of the lateral ends 77, 78 to a central support 89 of the post 70 that is disposed centrally between the lateral ends 77, 78. The central support 89 extends from the overhanging portion 84 to the lower end 75 of the post 70. As such, a volume of the post 70 between the front and rear faces 92, 93 is mostly hollow.

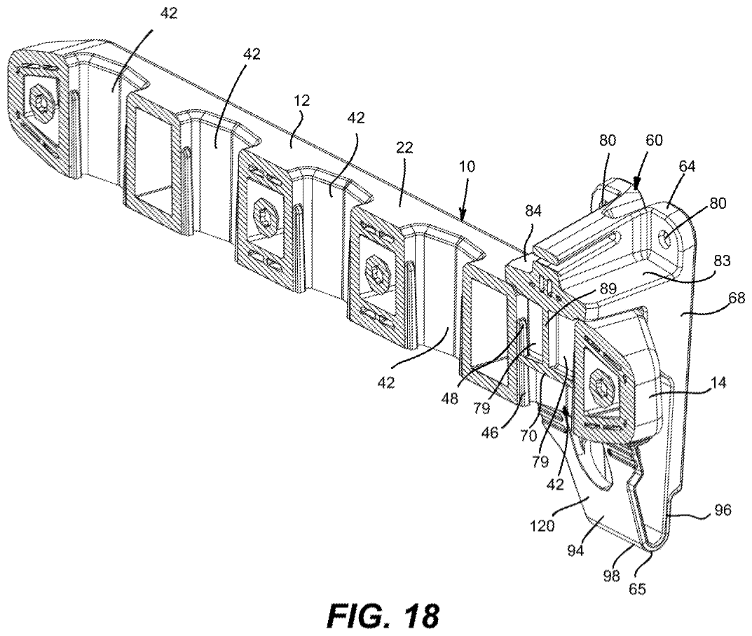

At the lower end 75 of the post 70, the outer peripheral surface 72 also defines the two grooves 74 which are configured to slidingly receive the ribs 46 of the corresponding post-receiving portion 40 therein. Notably, the grooves 74 are shaped to receive the ribs 76 of any one of the post-receiving portions 40 therein. The recesses 79 extend above respective ones of the grooves 74 such that, as shown in FIG. 18, when the ribs 46 are slid into the grooves 74, the ribs 46 partially extend within the recesses 79.

It is contemplated that, in other embodiments, the post 70 could be solid instead of hollow (i.e., the recesses 79 could be omitted), in which case the grooves 74 could extend along a greater proportion of the height of the post 70 such that when the ribs 46 are slid into the grooves 74, the upper rib ends 48 are positioned in the grooves 74.

Furthermore, it is contemplated that, in embodiments in which the post openings 42 are shaped differently, the post 70 of the accessory connector 60 would have a corresponding shape. In addition, it is contemplated that the post 70 could have a shape different from the post openings 42 so long as the post 70 fits within the post openings 42 and has the grooves 74 to engage the ribs 46.

The accessory connector 60 also includes a movement limiter 94 configured to limit movement, particularly vertical movement, of the accessory connector 60 relative to the connecting base 10. Notably, in use, the accessory system 100 may be subject to momentums (e.g., generated by movement of the vehicle 200) that force the post 70 upward. As the post 70 is kept in its vertical position within the post opening 42 solely by a weight of the accessory connector 60 (i.e., by gravity), the post 70 could accidentally disengage the post opening 42 if a sufficiently strong upward force is exerted thereon. The movement limiter 94 is provided to prevent such a disengagement of the post 70 from the post opening 42.

The movement limiter 94 is connected to the supporting portion 82, notably extending from a lower end of the supporting portion 68. The movement limiter 94 thus defines the lower end 65 of the accessory connector 60. The movement limiter 94 has a fixed portion 96 which extends downward from the lower end of the supporting portion 68. A looping portion 98 of the movement limiter 94 extends from the fixed portion 96, notably defining the lower end 65 of the accessory connector 60, and loops back upwardly from the lower end 65. In this embodiment, the looping portion 98 is curved. A movable portion 120 of the movement limiter 94 extends upwardly from the looping portion 98 and is disposed rearwardly from the fixed portion 96. As will be explained below, the movable portion 120 of the movement limiter 94 is movable relative to the fixed portion 96.

The movable portion 120 defines an opening 125 for accessing the fastening opening 80 aligned therewith. The movable portion 120 defines a tip 124 of the movement limiter 94 and an abutting shoulder 122 disposed vertically lower than the tip 124. The abutting shoulder 122 defines an upwardly-facing surface 123. A tip section 126 of the movable portion 120 defines the tip 124 and defines a rear tip surface 127. The tip section 126 extends generally perpendicular to the abutting shoulder 122. The rear tip surface 127 extends along a plane offset from a rear surface 129 defined by a section of the movable portion 120 extending downward from the tip section 126.

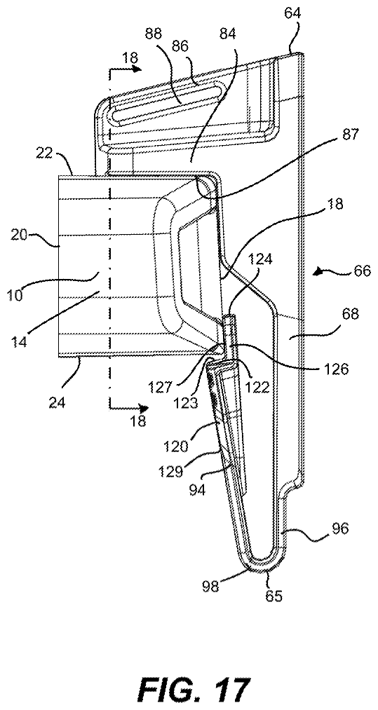

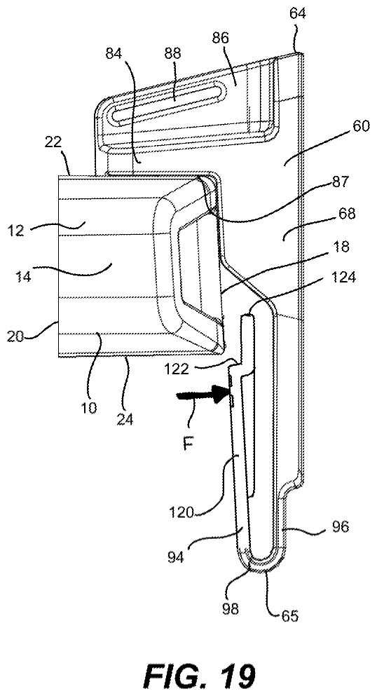

The movable portion 120 of the movement limiter 94 is movable between a limiting position illustrated in FIG. 17, and a free position illustrated in FIG. 19. As shown in FIG. 17, in the limiting position, the movable portion 120 is positioned to interact with the connecting base 10 to limit sliding movement of the post 70 within the corresponding post opening 42. In particular, the rear surface 127 of the tip section 126 abuts the front surface 18 of the connecting base 10 in order to position the abutting shoulder 122 such that, in response to the post 70 moving upward within the post opening 42, the upwardly-facing surface 123 of abutting shoulder 122 abuts the lower surface 24 of the connecting base 10 to limit upward movement of the post 70 and thereby prevent disengagement of the post 70 from the connecting base 10. The tip section 126 thus guides the position of the abutting shoulder 122.

As shown in FIG. 19, in the free position, the movable portion 120 of the movement limiter 94 is positioned to allow sliding movement of the post 70 within the corresponding post opening 42. That is, in the free position, upward movement of the post 70 within the post opening 42 is unrestricted by the movement limiter 94. Notably, in the free position, the rear surface 127 of the tip section 126 is spaced from the front surface 18 of the connecting base 10 and the abutting shoulder 122 is positioned such that, if the accessory connector 60 is translated upwardly, the abutting shoulder 122 remains clear of the lower surface 24 of the connecting base 10.

As shown in FIG. 19, the movement limiter 94 is movable from the limiting position to the free position by applying a force F on the movable portion 120 of the movement limiter 94. As can be seen, the force F is exerted to move the movable portion 120 forward toward the supporting portion 68. As such, the tip 124 of the movement limiter 94 is further from the supporting portion 68 in the limiting position than in the free position. The user thus moves the movement limiter 94 to the free position in order to disengage the post 70 from the corresponding post opening 42. For instance, when the user wants to remove the accessory 105 from the vehicle 200, the user actuates the movement limiter 94 to the free position and can then slide the post 70 upward to remove the post 70 from the post opening 72.

The movement limiter 94 is biased to be in the limiting position and therefore the movable portion 120 returns to the limiting position once the force F is no longer applied by the user. In particular, in this embodiment, the shape and thickness of the movement limiter 94 is such that the movement limiter 94 acts as a spring. In other words, the movable portion 120 returns to the limiting position by virtue of elastic deformation of the material of the movement limiter 94, particularly at the looping portion 98 thereof.

Due to the function of the movement limiter 94 to be able to clip onto the connecting base 10, the accessory connector 60 may also be referred to as a “clip”.

It is contemplated that, in other embodiments, the movement limiter 94 may be configured otherwise. For example, in some embodiments, the movement limiter 94 could include one or more springs between the supporting portion 68 and the movement limiter 94.

Returning now to FIGS. 1 and 2, the two accessory connectors 60 are engaged with the connecting base 10 to secure the accessory 105 to the vehicle 200. Notably, the two posts 70 of the accessory connectors 60 are inserted into two of the post openings 42 of the connecting base 10 (in this embodiment, into the two furthest post openings 42 of the connecting base 10) in a downward direction. The lower surface 87 (FIG. 17) of the overhang portion 84 abuts the upper surface 22 of the connecting base 10 to set the vertical position of the posts 70 within the post openings 42. The movement limiter 94 of each accessory connector 60 automatically assumes the limiting position to limit vertical movement of the corresponding post 70.

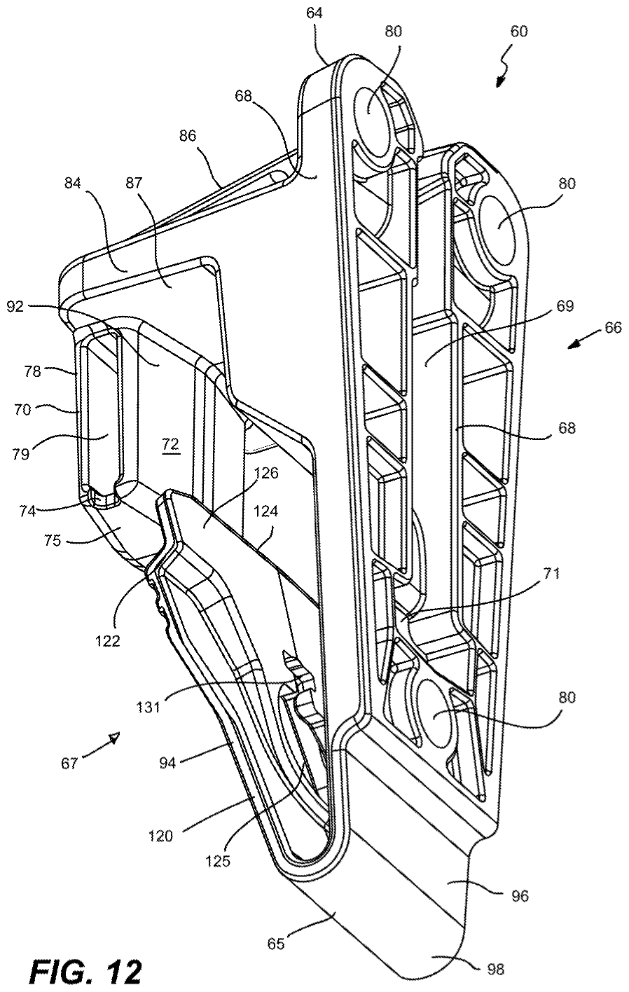

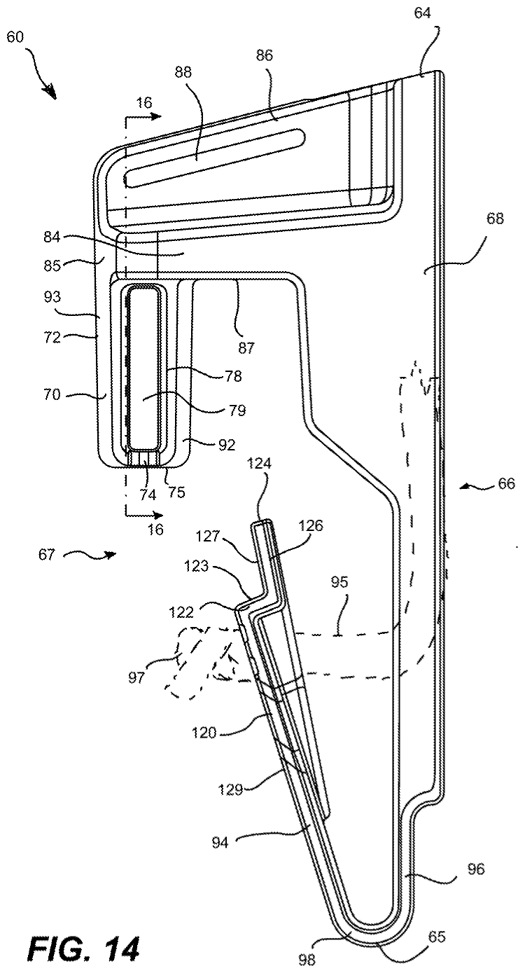

As shown in FIGS. 1 and 2, in this embodiment, the two accessory connectors 60 are interconnected by the link 90. The link 90 facilitates the removal of the posts 70 of both interconnected accessory connectors 60 from the corresponding post openings 42 of the connecting base 10. In particular, the link 90, which in this embodiment is a strap, is connected by a respective flexible member 95 (partially illustrated in dashed lines in FIG. 14) such as a rope to each accessory connector 60. With reference to FIG. 12, each flexible member 95 is inserted into a vertical slot 69 defined by the supporting portion 68 and through an opening 71 defined by the supporting portion 68. The flexible member 95 is then inserted through the opening 125 defined by the movable portion 120 of the movement limiter 94 and positioned in part within an upper T-shaped portion 131 of the opening 125. A knot 97 is formed at the end of the flexible member 95 on the front side of the movable portion 120 such that the end of flexible member 95 cannot be pulled out through the opening 125. Alternatively, a stopper could be provided instead of the knot 97. Thus, when the link 90 is pulled upward, each flexible member 95 pulls the movable portion 120 of the corresponding accessory connector 60 rearward, namely as the knot 97 applies the force F to move the movable portion 120 to the free position. The movement limiters 94 of both accessory connectors 60 therefore cease restricting the upward motion of the posts 70 such that the user can remove the accessory connectors 60 from engagement with the respective accessory connector 60 in order to remove the storage container 105 from the connecting base 10.

Although the storage container 105 is shown in FIGS. 1 and 2 as being connected to two accessory connectors 60, it is contemplated that the storage container 105 could be connected to a single accessory connector 60. As such, the storage container 105 (or other accessory) could be connected to the connecting base 10 by a single post 70.

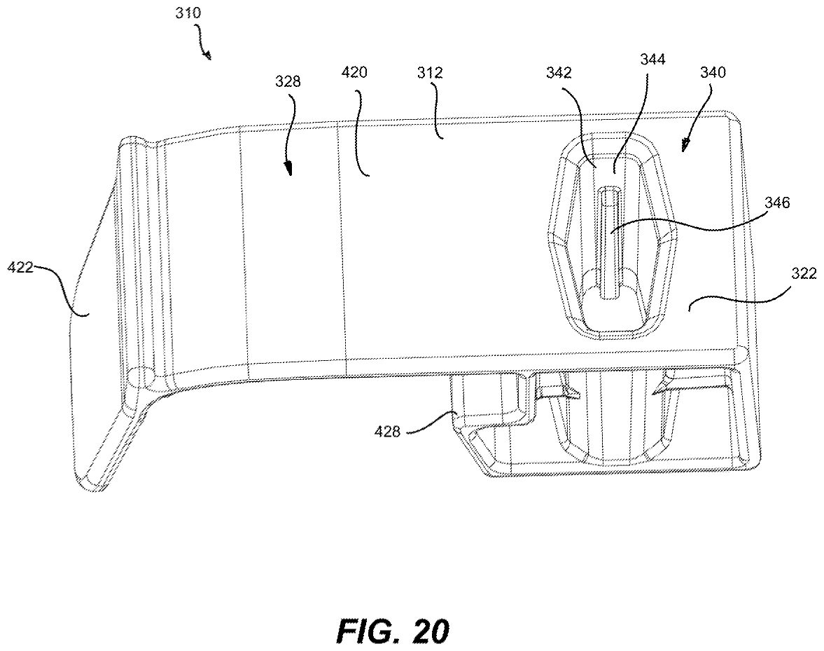

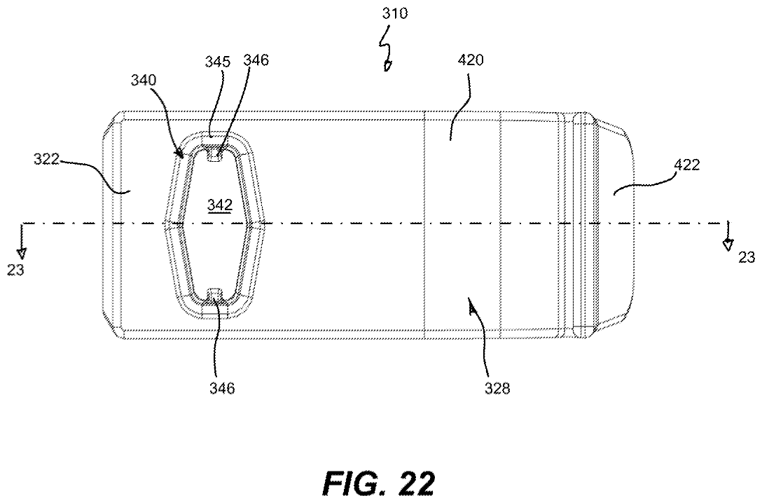

Turning now to FIGS. 20 to 23, an alternative embodiment of the connecting base 10 will now be described. Notably, a connecting base 310 is provided having a single post-receiving portion 340 and thereby defining a single post opening 342. The parts of the connecting base 310 corresponding to those described above with regard to the connecting base 10 will be referred to herein with like reference numerals having a “3” in front thereof. The parts of the connecting base 310 have the same configuration as the corresponding parts of the connecting base 10 unless otherwise specified.

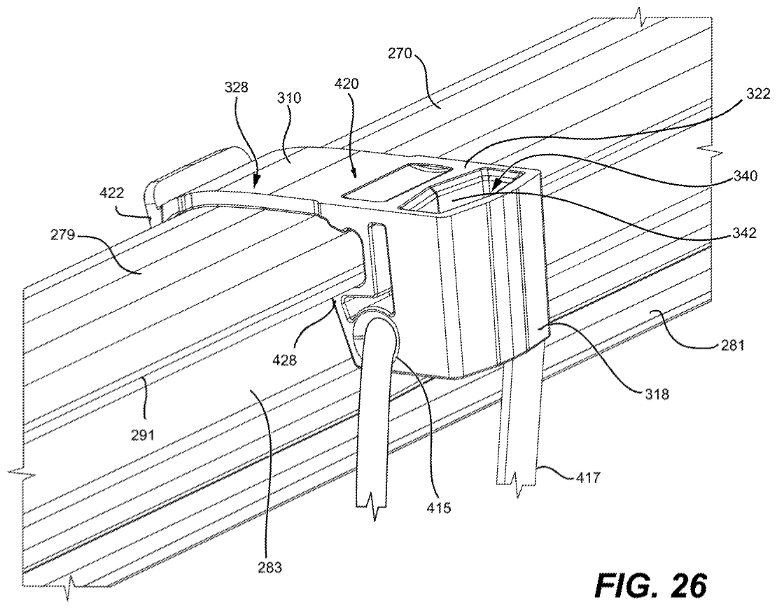

A base body 312 of the connecting base 310 has a front surface 318, as well as an upper surface 322 and a lower surface 324. In this embodiment, the post opening 342 of the post-receiving portion 340 extends from the upper surface 322 to the lower surface 324 (i.e., through the base body 312). The post-receiving portion 340 includes the ribs 346 that protrude from the inner peripheral surface 344 defining the post opening 342. Near its lower surface 324, the connecting base 310 defines a rope aperture 415 extending generally horizontally (i.e., in a direction perpendicular to the post opening 342). The rope aperture 415 is configured to optionally receive a rope 417 (FIG. 26) therein for tying the accessory 105 to the connecting base 310. This may be useful for example in cases in which it is desired for the accessory 105 to remain tied to the connecting base 310 even when the accessory 105 is disengaged from the connecting base 310, such as for example to prevent loss of the accessory 105. For instance, this may be the case when the accessory 105 is a fender for a watercraft.

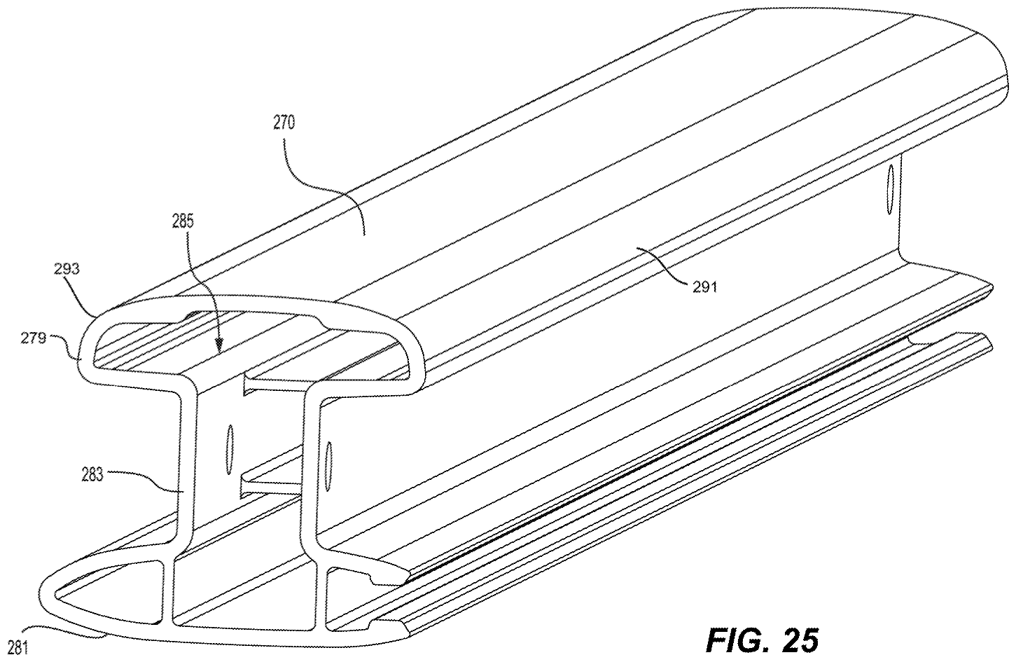

The attachment portion 328 of the connecting base 310 is configured to be removably connected to a rail 270 of the vehicle 200. Notably, as shown in FIG. 24, in this embodiment, the vehicle 200 is a watercraft having a deck 220, a hull 232 supporting the deck 220, and a barrier structure 250 surrounding the deck 220 and located along a periphery of the watercraft 200. The barrier structure 250 includes a wall 264 and the rail 270 which extend along at least the lateral portions 256 of the barrier structure 250. The rail 270 is configured for grabbing by a user's hand. The rail 270 is thus also commonly referred to as a “hand rail” or a “grab rail”. As can be seen in FIG. 25, the cross-sectional profile of the rail 270 is generally I-shaped, notably including a wide upper portion 279, a wide lower portion 281 and a narrow intermediate portion 283 extending between the wide upper and lower portions 279, 281. In this embodiment, the rail 270 is an extruded component and defines an interior hollow space 285 therein. The watercraft 200 and its rails 270 is described in greater detail in U.S. patent application Ser. No. 17/219,568, filed Mar. 31, 2021, the entirety of which is incorporated by reference herein.

In this embodiment, the attachment portion 328 of the connecting base 310 is configured to be clipped toollessly onto the rail 270. In other words, the attachment portion 328 can be clipped onto the corresponding rail 270 without using any tools (e.g., a screwdriver, a wrench, etc.) such that a user can clip the attachment portion 328 onto the corresponding rail 270 simply by handling the attachment portion 328 directly with the user's hand. The connecting base 310 may thus also be referred to as a “clip”.

The attachment portion 328 is shaped to surround part of the corresponding rail 270 when the connecting base 310 is connected to the rail 270. Notably, the attachment portion 328 has a similar shape as a cross-sectional profile of the wide upper portion 279 of the rail 328. In particular, an upper part 420 of the attachment portion 328 extends from the upper surface 322 in a generally horizontal direction (i.e., transversally to the direction in which the post opening 342 extends). A rear part 422 of the attachment portion 328 extends downwardly from the upper part 420 at an end of the upper part 420 opposite the post-receiving portion 340. The rear part 422 has a plurality of ridges 423 for facilitating grasping by a user's hand. The ridges 423 are provided on an inner side 424 of the rear part 422. The inner side 424 of the rear part 422 faces toward the post-receiving portion 340.

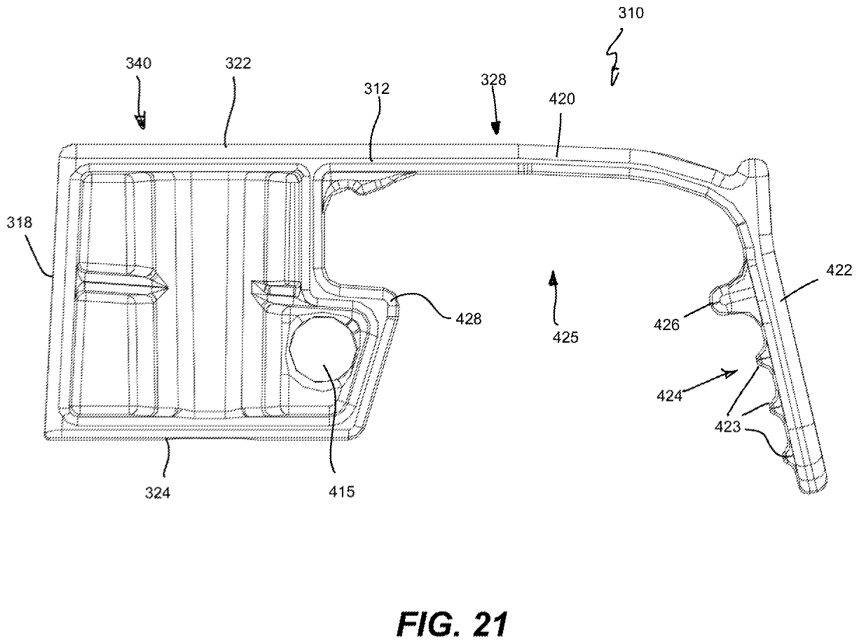

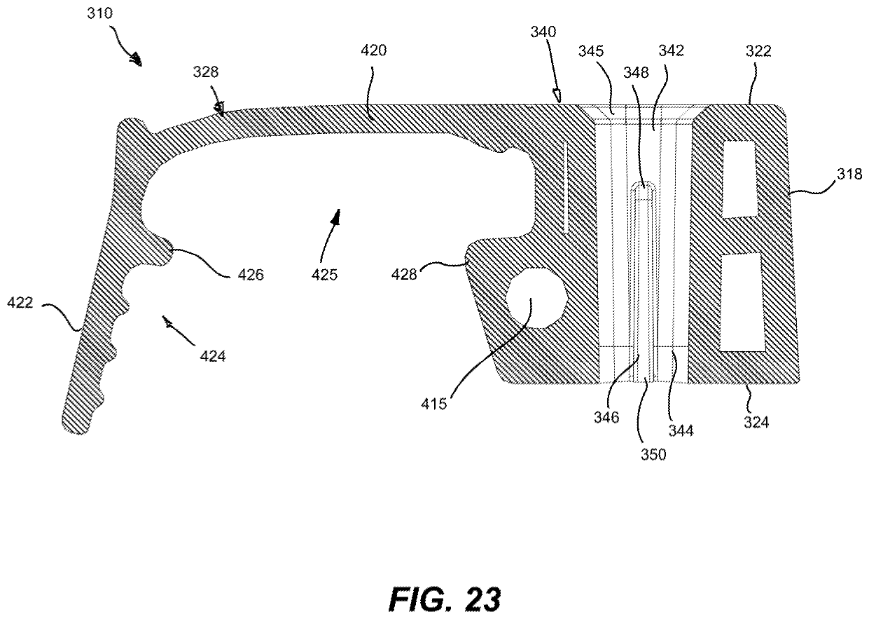

In order for the connecting base 310 to be clipped onto the corresponding rail 270, as shown in FIGS. 21 and 23, the attachment portion 328 cooperates with the post-receiving portion 340 to define a rail-receiving recess 425 therebetween for receiving part of the rail 270. In particular, the rail-receiving recess 425 has a cross-section that is shaped and sized to accommodate the cross-sectional profile of the wide upper portion 279 of the rail 270. In this embodiment, the cross-section of the rail-receiving recess 425 is generally C-shaped. The cross-section of the rail-receiving recess 84 can have any other suitable shape in other embodiments in accordance with the shape of cross-sectional profile of the rail 270. To form the C-shape of the cross-sectional profile of the rail-receiving recess 425, in this embodiment, the rear part 422 of the attachment portion 428 has an upper protrusion 426 that protrudes toward the post-receiving portion 340 on the inner side 424 of the rear part 422. Moreover, the post-receiving portion 340 has a shoulder 428 facing inwardly toward the rear part 422 of the attachment portion 328.

The attachment portion 328 is dimensioned to be sufficiently flexible so as to be elastically deformed when being clipped onto the rail 270. For instance, the thickness of the upper part 420 of the attachment portion 328 is small enough to allow the upper part 420 to bend elastically under an applied force. Moreover, in this embodiment, the connecting base 310 is made of polymeric material. It is contemplated that, in other embodiments, the connecting base 310 could be made of the same material as the corresponding accessory connector 60. The material of the connecting base 310 contributes in allowing the attachment portion 328 to be sufficiently flexible to be elastically deformed when being clipped onto the rail 270.

In order to mount the connecting base 310 to the rail 270 as shown, the connecting base 310 is positioned atop the rail 270 with the post-receiving portion 240 near an outer end 291 of the wide upper portion 279 of the rail 270 and the rear part 422 of the attachment portion 328 near an inner end 293 of the wide upper portion 279 of the rail 270. The attachment portion 328 is then pushed downwardly onto the rail 370. The protrusion 426 of the attachment portion 328 thus slides down the curved shape of the inner end 293 of the wide upper portion 270 of the rail 270 while the upper part 420 elastically bends so that the rear part 422 moves away from the post-receiving portion 340 until the protrusion 426 moves down past the inner end 293 of the wide upper portion 279 and the shoulder 428 moves down past the outer end 291 of the wide upper portion 279. As the protrusion 426 is moved below the inner end 293, the attachment portion 328 elastically deforms back to be in its original configuration. The upper part 420 thus springs back so that the protrusion 426 moves below the inner end 293 and the shoulder 428 moves below the outer end 291. The wide upper portion 279 of the rail 270 is thus received in the rail-receiving recess 425 and the connecting base 310 applies a force on both ends 291, 293 of the rail 270 such that the connecting base 310 is safely secured to the rail 270. If it desired to disconnect the connecting base 310 from the rail 270, a substantial force has to be applied on the rear part 422 of the attachment portion 328 to pull the rear part 422 away from the post-receiving portion 340 in order to disconnect the connecting base 310 from the rail 270. This is helpful to prevent the connecting base 310 from being accidentally disconnected from the rail 270. As can be seen in FIG. 26, in this embodiment, when the connecting base 310 is connected to the rail 270, the post-receiving portion 340 overhangs the rail 270. This can free up space on the deck 220 of the watercraft 100 when the accessory 105 is connected to the connecting base 310.

It is contemplated that, in some embodiments, the connecting base 310 could be connected to the rail 270 by using tools. Furthermore, in other embodiments, the connecting base 310 could be an integral part of the rail 270.

As will be understood, in this embodiment, a single accessory connector 60 is connected to the connecting base 310 via interaction between the post 70 of the accessory connector 60 and the post opening 342 of the connecting base 310. As such, in this embodiment, the accessory 105 is connected to a single accessory connector 60. For example, a fender could be connected to the accessory connector 60 for connecting the fender to the watercraft 200.

It will be appreciated that a connecting base 10 or 310 such as that described herein could be used in conjunction with various accessories other than a storage container or a fender. For example, an accessory system including the connecting base 10 or 310 could receive an accessory, such as a cup holder or a fishing rod holder, that includes a downwardly extending post 70.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A connecting base for connecting an accessory to a vehicle, comprising:
an attachment portion configured to be connected to the vehicle; and
at least one post-receiving portion connected to the attachment portion, each of the at least one post-receiving portion defining an opening configured to receive a post connected to the accessory, the opening being defined in an upper surface of the connecting base, each of the at least one post-receiving portion comprising:
an inner peripheral surface defining the opening, the inner peripheral surface being shaped to be at least partially mated with an outer peripheral surface of the post; and
a rib protruding from the inner peripheral surface, the rib being configured to engage a groove defined by the outer peripheral surface of the post.

2. The connecting base of claim 1, wherein the rib extends along a majority of a depth of the opening measured downward from the upper surface.

3. The connecting base of claim 1, wherein the rib extends generally vertically.

4. The connecting base of any one of claims 1 to 3, wherein:
the rib is a first rib;
the groove is a first groove, the outer peripheral surface of the post comprising a second groove;
each of the at least one post-receiving portion further comprises a second rib protruding from the inner peripheral surface for engaging the second groove defined by the outer peripheral surface of the post; and
the first and second ribs are disposed on opposite sides of the opening.

5. The connecting base of any one of claims 1 to 3, wherein the opening extends from upper surface of the connecting base to a lower surface of the connecting base.

6. The connecting base of any one of claims 1 to 3, wherein the opening has a generally hexagonal shape.

7. The connecting base of any one of claims 1 to 3, wherein the at least one post-receiving portion is a plurality of post-receiving portions.

8. The connecting base of claim 7, wherein a plane extends through the rib of each post-receiving portion of the plurality of post-receiving portions.

9. The connecting base of claim 7, wherein the connecting base is generally elongated in a given direction, the openings being spaced from one another in the given direction.

10. The connecting base of any one of claims 1 to 3, wherein the attachment portion is configured for removably connecting the connecting base to the vehicle.

11. The connecting base of claim 10, wherein:
the vehicle comprises a rail; and
the attachment portion is configured to be clipped toollessly onto the rail, the attachment portion being sufficiently flexible to be elastically deformed when being clipped onto the rail.

12. The connecting base of claim 11, wherein the attachment portion is configured to partially surround part of the rail to retain the connecting base onto the rail.

13. The connecting base of claim 12, wherein the attachment portion is configured to partially surround an upper portion of the rail.

14. The connecting base of any one of claims 1 to 3, wherein the attachment portion defines at least one fastening opening configured to receive a fastener to fasten the connecting base to the vehicle.

15. The connecting base of claim 14, wherein an axis of the at least one fastening opening extends in a direction generally perpendicular to a direction of insertion of the post into the opening of the at least one post-receiving portion.

16. An accessory system for a vehicle, comprising:
the connecting base of any one of claims 1 to 3; and
an accessory connector configured to be connected to an accessory, the accessory connector comprising a post configured to be received in the opening of the at least one post-receiving portion of the connecting base,
the post comprising an outer peripheral surface having a shape corresponding to the inner peripheral surface of the at least one post-receiving portion, the outer peripheral surface defining a groove configured to slidingly receive the rib of the post-receiving portion therein.

17. The accessory system of claim 16, wherein the accessory connector further comprises:
a supporting portion configured to be connected to the accessory; and
an overhanging portion extending from the supporting portion, the post extending downward from the overhanging portion.

18. The accessory system of claim 17, wherein the supporting portion is configured to be connected to the accessory on a side of the supporting portion opposite the overhanging portion.

19. The accessory system of claim 17, wherein:
the accessory connector further comprises a movement limiter connected to the supporting portion;
the movement limiter is movable between a first position and a second position;
in the first position, the movement limiter is positioned to interact with the connecting base to limit sliding movement of the post within the opening; and
in the second position, the movement limiter is positioned to allow sliding movement of the post within the opening.

20. The accessory system of claim 19, wherein the movement limiter is biased to be in the first position.

21. The accessory system of claim 19, wherein:
the movement limiter is movable towards and away from the supporting portion; and
a tip of the movement limiter is further from the supporting portion in the first position than in the second position.

22. The accessory system of claim 16, wherein:
the at least one post-receiving portion of the connecting base includes a first post-receiving portion and a second post-receiving portion;
the accessory connector is a first accessory connector, the post being a first post configured to be received in the opening of the first post-receiving portion; and
the accessory system further comprises a second accessory connector configured to be connected to the accessory, the second accessory connector comprising a second post configured to be received in the opening of the second post-receiving portion.

23. The accessory system of claim 22, further comprising a link interconnecting the first and second accessory connectors for simultaneously removing the first and second posts from within the openings of the first and second post-receiving portions.

24. An accessory connector comprising:
a supporting portion configured to be connected to the accessory; and
a post connected to the supporting portion, the post being configured to be received in an opening of a connecting base,
the post comprising an outer peripheral surface defining a groove configured to slidingly receive a rib protruding from an inner peripheral surface of the connecting base defining the opening.

25. The accessory connector of claim 24, further comprising an overhanging portion extending from the supporting portion, the post extending downward from the overhanging portion.

26. The accessory connector of claim 25, wherein the supporting portion is configured to be connected to the accessory on a side of the supporting portion opposite the overhanging portion.

27. The accessory connector of any one of claims 24 to 26, wherein:
the accessory connector further comprises a movement limiter connected to the supporting portion;
the movement limiter is movable from a first position to a second position;
in the first position, the movement limiter is positioned to interact with the connecting base to limit sliding movement of the post within the opening; and
in the second position, the movement limiter is positioned to allow sliding movement of the post within the opening.

28. The accessory connector of claim 27, wherein the movement limiter is biased to be in the first position.

29. The accessory connector of claim 27, wherein:
the movement limiter is movable towards and away from the supporting portion; and
a tip of the movement limiter is further from the supporting portion in the first position than in the second position.
